(19) United States
(12) Patent Application Publication
(10) Pub. No.: US 2002/0042861 A1
(43) Pub. Date: Apr. 11, 2002

(54) Apparatus and method for implementing a variable block size cache

(76) Inventor: Gautam Nag Kavipurapu, Dallas, TX (US)

Correspondence Address: David M. Mundt, Esq., Eugene M. Cummings, P.C., Bank One Plaza, #3180, Chicago, IL, 60603, US

(21) Appl. No.: 10/015,099

(22) Filed: Dec. 11, 2001

Related U.S. Application Data
(63) Continuation-in-part of application No. 08/965,760, filed on Nov. 7, 1997.

(51) Int. Cl. G06F 12/08

(52) U.S. Cl. 711/118; 711/170; 711/212; 711/3; 711/137; 711/136

(57) ABSTRACT

A physically non-distributed microprocessor-based computer includes a microprocessor, and a random access memory device, a mass storage device, and an input-output port device, all operable from the microprocessor and including an interface for receiving and transmitting data in packet form. A novel packet-based data channel extends between the microprocessor and the interfaces of the devices to provide communication between the microprocessor and the devices. By varying the blank size of the cache in accordance with actual data transmission requirements improved computer performance is achieved.

### SPECIFICATION

This is a Continuation-in-Part of application Ser. No. 08/965,760, filed Nov. 7, 1997.

### BACKGROUND OF THE INVENTION

In a traditional memory hierarchy in a computer system the memory is organized into several levels. The highest level of memory is the most expensive and fastest, and also physically closest to the processor. An example of this is shown in FIG. 1. The top level of the memory hierarchy, the registers in the processor, store the raw data that needs to be processed by the execution units of the processor in accordance with scheduling determined by the controller in the processor.

The next level of memory hierarchy is the level 1 or L1 cache. The L1 cache is usually composed of single or multiported SRAM. The data organization of the SRAM cache in current art is done in two halves. These halves are respectively the instruction cache and the data cache. The instruction cache stores the instructions or “op-codes” that the execution units of the processor use. The format of the op-codes or instructions, as stored in the L1 cache is determined by the parsing of the instructions in hardware or in software. If they are parsed in hardware then they are stored as high level instructions. If they are parsed in software, i.e., the compiler, they are stored as op-codes or low level instructions.

A functional organization of the L1 cache is shown in FIG. 2. This L1 cache belongs to the digital alpha processor. Another organization is shown in FIG. 3, this L1 cache belongs to the Pentium processor. The same techniques that are employed in current system memories are employed in the caches to maximize the efficiency of the memory subsystem design.

The address generated by the processor to access the memory is split up into several parts. This interpretation by the cache controller is shown in FIG. 4. The first part or tag is used to locate which “bank” a word resides in. The next part, the Index is used to locate the line number in that bank and the third part, or offset, locates the position of the word (Instruction or data) within that Block/line. The size of the words stored in the L1 cache is equal to the size of the words processed by the execution units of the processor. This implies that all the words stored in the instruction cache and the data cache are of the same respective sizes. This might not be true for CISC instruction words or hybrid instruction words, as used in the Pentium processor. In this case the instruction words might vary in size. This is the reason that the offset is necessary to specify where the word starts from the first bit in the Block/line. The whole address is decoded by the cache controller.

Another technique is employed in the caches which gives rise to “banks.” This is called the associativity of the cache. The L1 cache can be organized as set-associative, fully associative, m-way associative.

The size of the banks or the pages in the memory subsystem is determined by the internal organization of the L1 cache. An example of this is: Say, the internal L1 cache of the processor is divided into data and code caches of size 8 kb. These are split into two halves if they are 2-way set associative, i.e. two virtual banks of cache lines of 4 kb each. If the processor uses 32-bit addressing then the total address space is 4GB (2\mathring{}). This is divided into pages of the size of each of the banks/ways/sections of the L1 cache. In this case there would be 4GB/4KB pages=1 Million or 1M. Each of these pages is further split up into lines. The line size in each of the pages is equal to the physical width of the line in each of these banks/ways of the cache. If the internal cache (L1) is organized as being 32 Bytes wide then there are 4096 Bytes/32 Bytes lines in the page. For addressing main memory a different page size might be used.

The data is stored in the L1 instruction cache of the Pentium as shown in FIG. 5. The data is stored in the L1 data cache as shown in FIG. 6. A quad word (QW) is 8 Bytes and a double word (DW) is 4 Bytes.

If the above mentioned organization of the memory is used, then one needs 20 bits to address each of the individual pages. Then, to address any of the 128 lines one needs 7 bits, to address each the individual bytes within the 32 Byte line one needs 5 bits. This explains the 32 bit address and the way the cache interprets the address. When the 32 bit physical address is applied to the bus all 32 bits are used to decide in which page the data is contained and in which line within the page the data is located in and which word in that line is the actual the data word.

On a write to memory the control unit inside the processor issues the write instruction. Which is parsed the same way and stored in the cache. There are several policies that are followed to maintain coherency between different levels of the memory hierarchy. This avoids the different hazards associated with memory accesses.

On a miss in the L1 cache of the required word, the next level of the memory is accessed outside the processor. This implies access to either the system memory or the level 2 cache (L2 cache), if it is present.

The L2 cache organization is much simpler. It is organized into banks (same as the system memory) with an external cache controller (this usually resides in the system controller of the computer). An example of an L2 cache is shown in FIG. 7, since once there is a miss in the L1 cache inside the processor, an access to the external memory elements is generated. These external memory elements are composed of the L2 cache and the system memory as shown in FIG. 8.

The external, physical address that is generated by the processor bus control unit in conjunction with the BTB, TLB (if they are present), is interpreted as shown in FIG. 9 by the cache controller for the L2 cache. The appropriate interface and control signals are then asserted by the controller to enable the operation of the L2 cache.

### SUMMARY OF THE INVENTION

The problem with the above described architecture is that the data that is read from the system memory or other memory to fill the cache lines, in all levels of the cache, is of a fixed size. The processor or the bus controller always fetches data that is equivalent to one processor L1 cache line. In the example cache line organization that we have shown in FIG. 6 or FIG. 7, this requires fetching of four quad words (32 Bytes of data) or 8 double words of data for the data cache. The problem with this organization of a fixed cache line and a fixed block size is that it always generates memory accesses which retrieve data in the amount of one block or cache line size. If the accesses are to consecutive locations in memory or to different locations in memory, it requires the processor to generate four memory access cycles, or as it is commonly practiced, a burst cycle is generated.

The present invention alleviates this defect. By keeping track of the hit rates within areas of the address space, the invention can generate request to storage when the number of requested bytes more precisely matches the hit rate for this area of the address space.

Thus, the present invention will prefetch more data when there is a miss to a heretofore high-hit rate area of the address space. Conversely, the invention will prefetch less data when there is a miss to a heretofore low-hit rate area of the address space.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures of which like reference numerals identify like elements, and in which:

FIG. 1 depicts a typical memory hierarchy of a computer constructed in accordance with the invention.

FIG. 2 depicts a typical Data cache of a computer constructed in accordance with the invention.

FIG. 3 depicts a typical Instruction cache of a computer constructed in accordance with the invention.

FIG. 4 depicts an address block for a cache controller of a computer constructed in accordance with the invention.

FIG. 5 depicts an I-cache line of a computer constructed in accordance with the invention.

FIG. 6 depicts a D-cache line of a computer constructed in accordance with the invention.

FIG. 7 shows an L2-cache of a computer constructed in accordance with the invention.

FIG. 8 shows a typical PC architecture.

FIG. 9 shows typical physical address radials.

FIG. 10 shows a typical microprocessor based system.

FIG. 11 shows a data path between processor and memory.

FIG. 12 shows a timing diagram for a typical read request.

FIG. 13 shows a link interface at system level.

FIG. 14 shows a link interface circuit block diagram.

FIG. 15 shows various packet types.

FIG. 16 shows various packet structures.

FIG. 17 shows a linc cache interface.

FIG. 18a shows cache line formats for one bank.

FIG. 18b shows a two bank linc cache implementation.

FIG. 19 shows a processor node read protocol flow diagram.

FIG. 20 shows a memory node read protocol flow diagram.

FIG. 21 shows a history register high level block diagram.

FIG. 22 shows a high level block diagram of a bit counter.

FIG. 23a shows hit counters at a given time, T.

FIG. 23b shows hit counters at time T+1.

FIG. 24 shows a linear prefetch size flow diagram.

FIG. 25 shows a non-linear prefetch size flow diagram.

FIG. 26 shows normal probability distribution of hits for a given application over time.

FIG. 27 is an explanatory diagram of a point by point linear approximation of the hit distribution in FIG. 26.

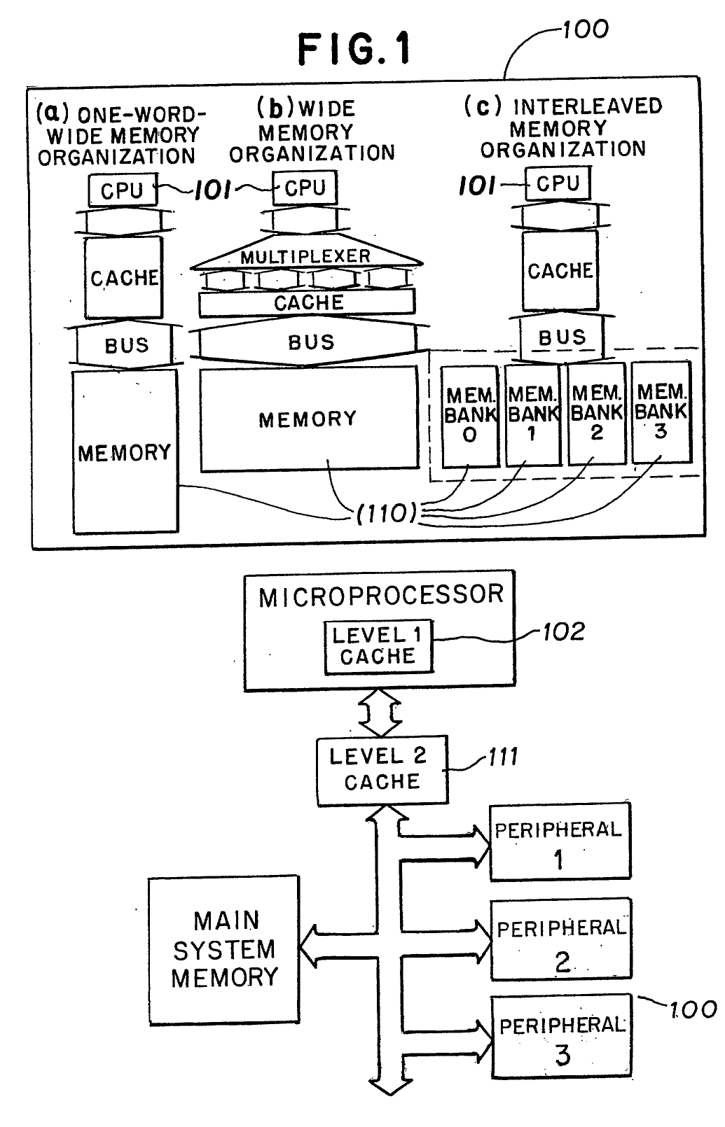

### DESCRIPTION OF THE PREFERRED EMBODIMENT

This invention implements a cache with a further variable line or block size as outlined in the previous patent application number. The virtual cache line or the block size allows one to effectively manage the bandwidth available between the memory and the processor or any other node present in a computer system as defined in application Ser. No. 08/965,760, filed Nov. 7, 1997.

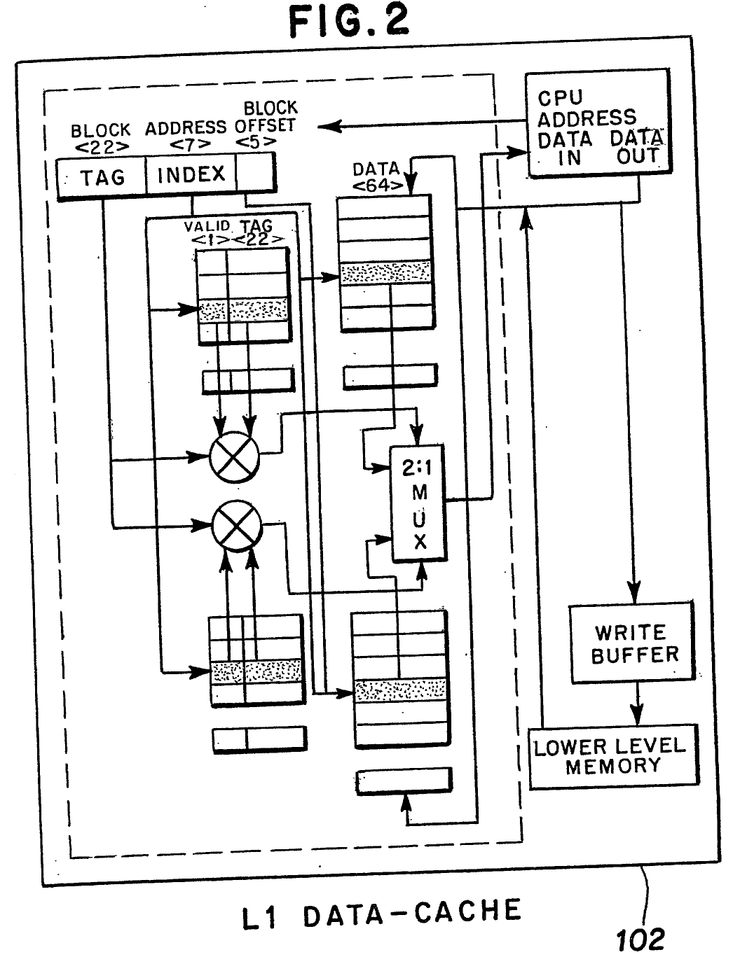

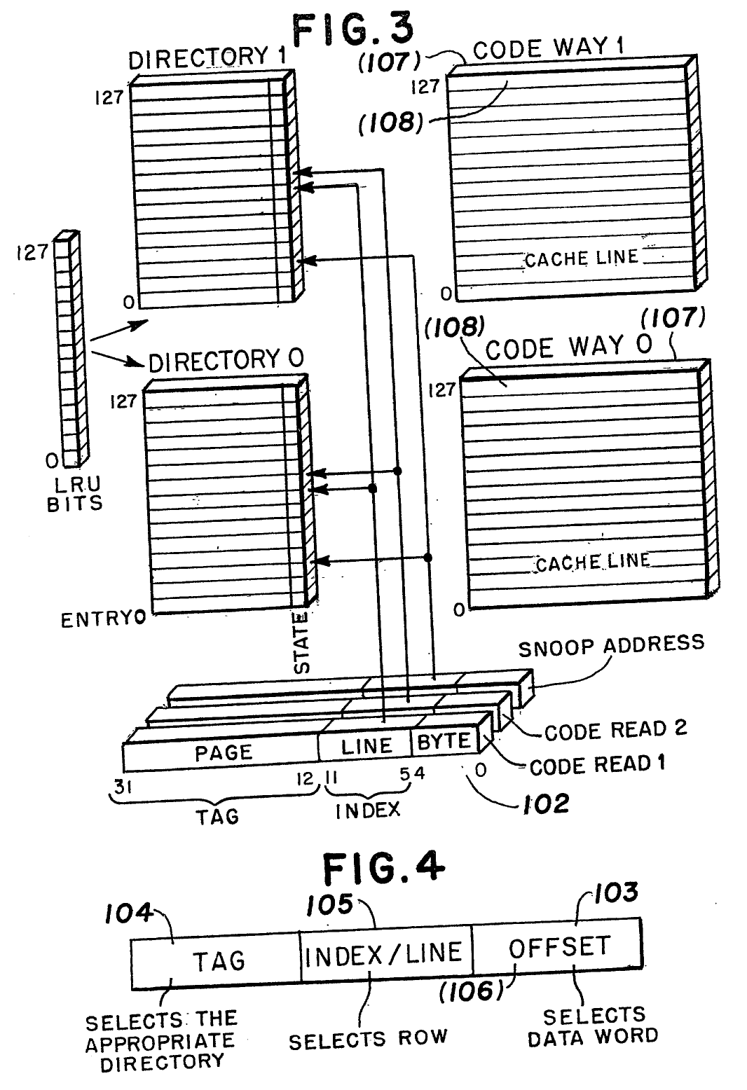

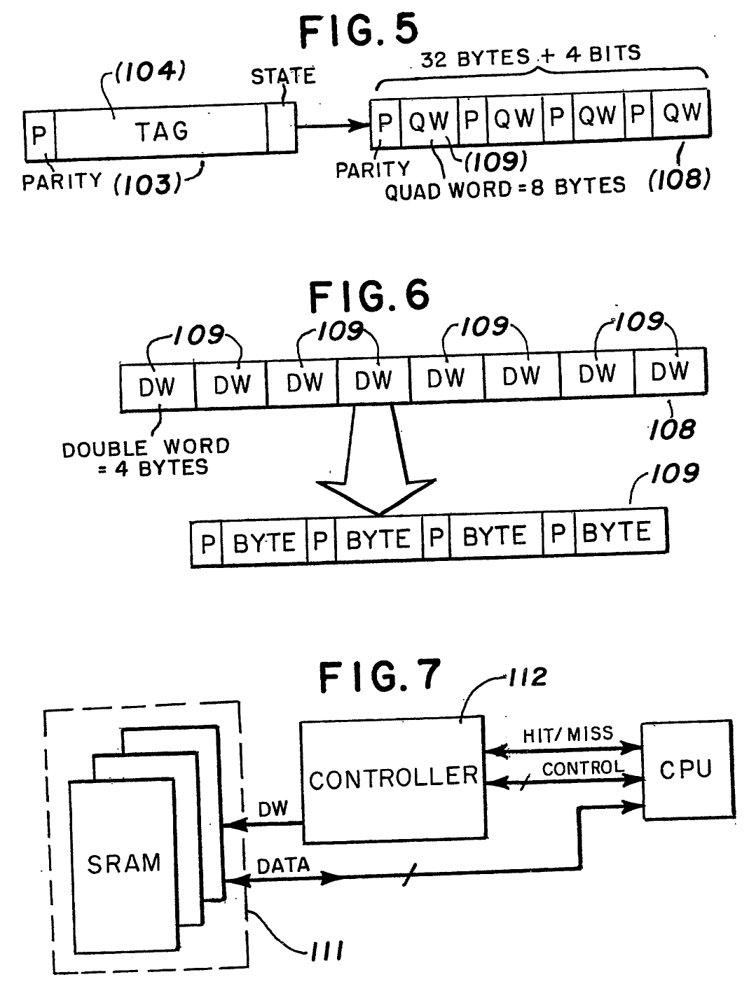

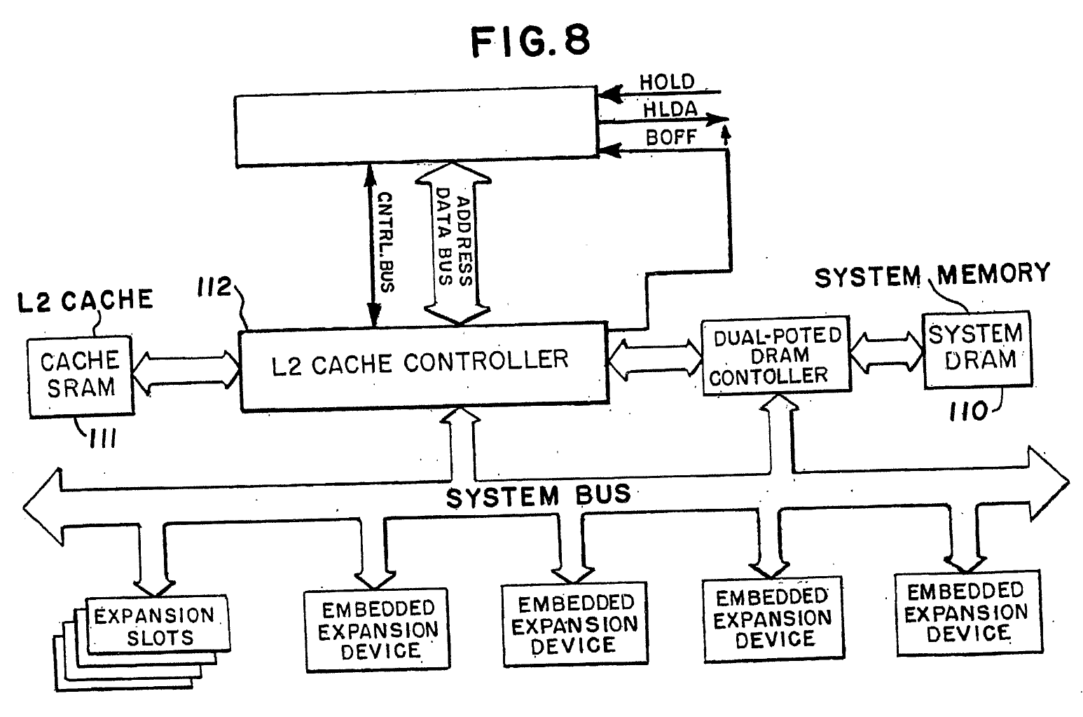

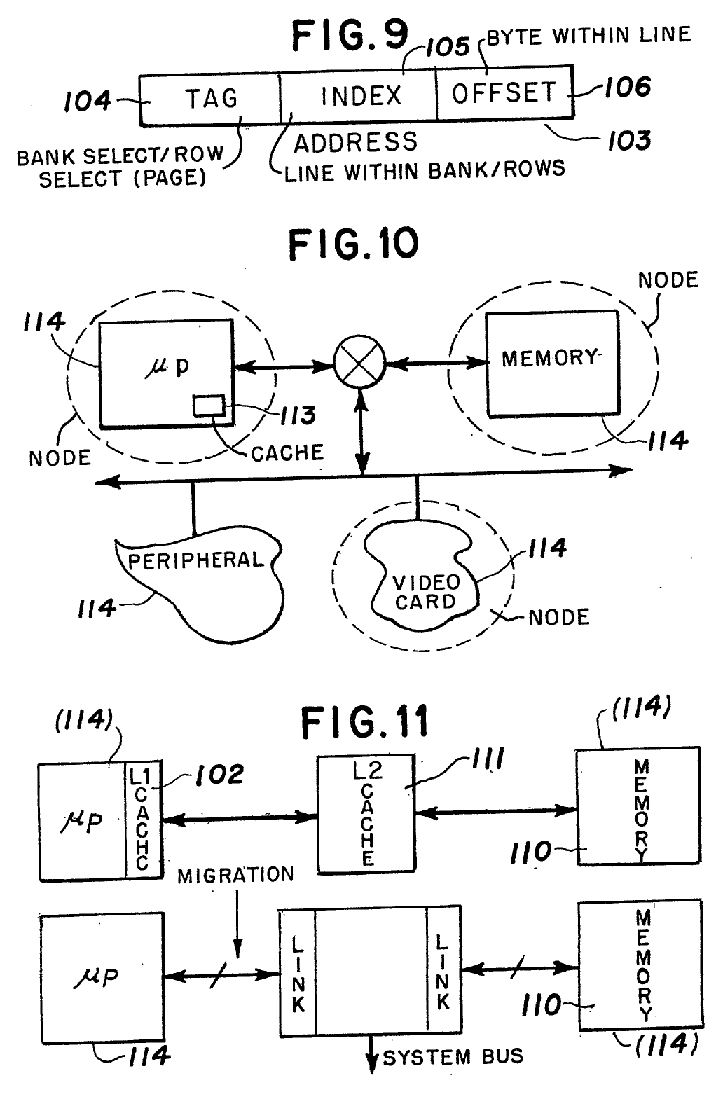

The methods and principles described in this document can be utilized to implement this feature in any of the caches described in FIGS. 2 and 3. An embodiment of a simple cache design is described in this application to explain the concept of a variable line/block size. It is assumed that the cache 113 is in a node 114 in a computer system, as in FIG. 10. The interface between this node 114 and the memory can be implemented by the packet based interconnect as demonstrated by the application Ser. No. 08/965,760, filed Nov. 7, 1997.

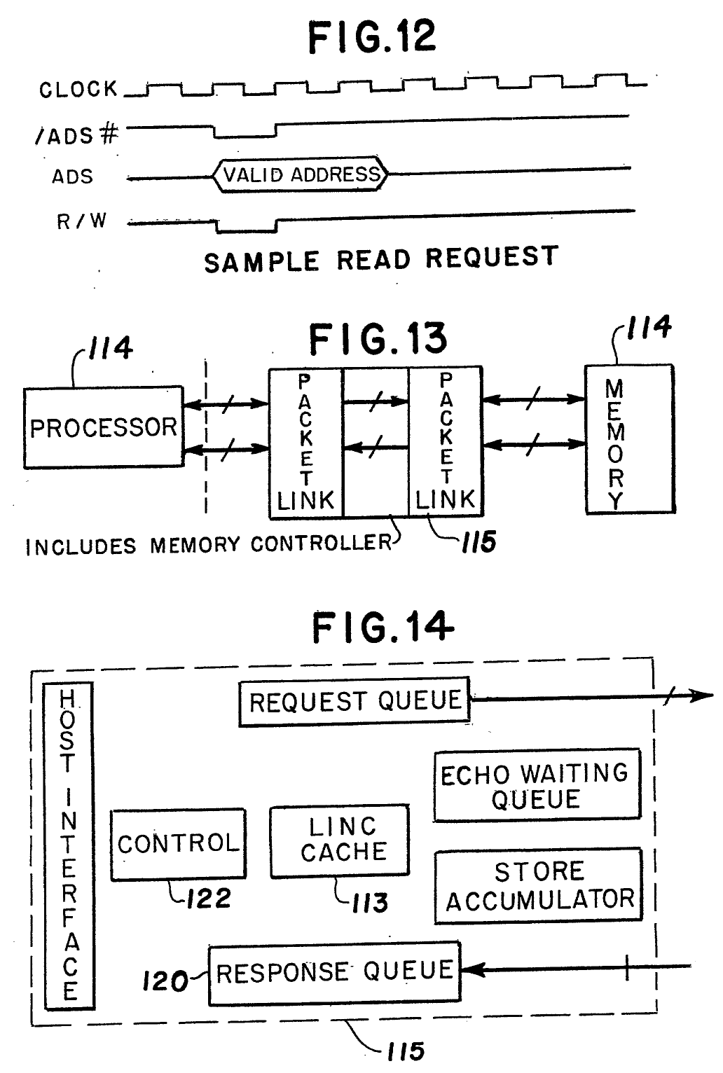

FIG. 11 shows one of the pathways that is implemented between the processor node 114 and the memory node 114. A read or load access by the processor generates a request packet 117 from the processor which in turn generates a response packet 119 from memory. The read access by the processor is as shown in FIG. 12. This is taken by the system controller or the memory controller and used to generate the appropriate memory signals.

A packet based interconnect channel 115 between the processor node 114 and the memory node 114 is assumed to have the structure as shown in FIG. 13. The functional block diagram of the packet link is shown in FIG. 14. The packet link 115 generates four broad classes of packets.

1) request 117

2) response 119

3) Idle 116

4) Request Echo 118

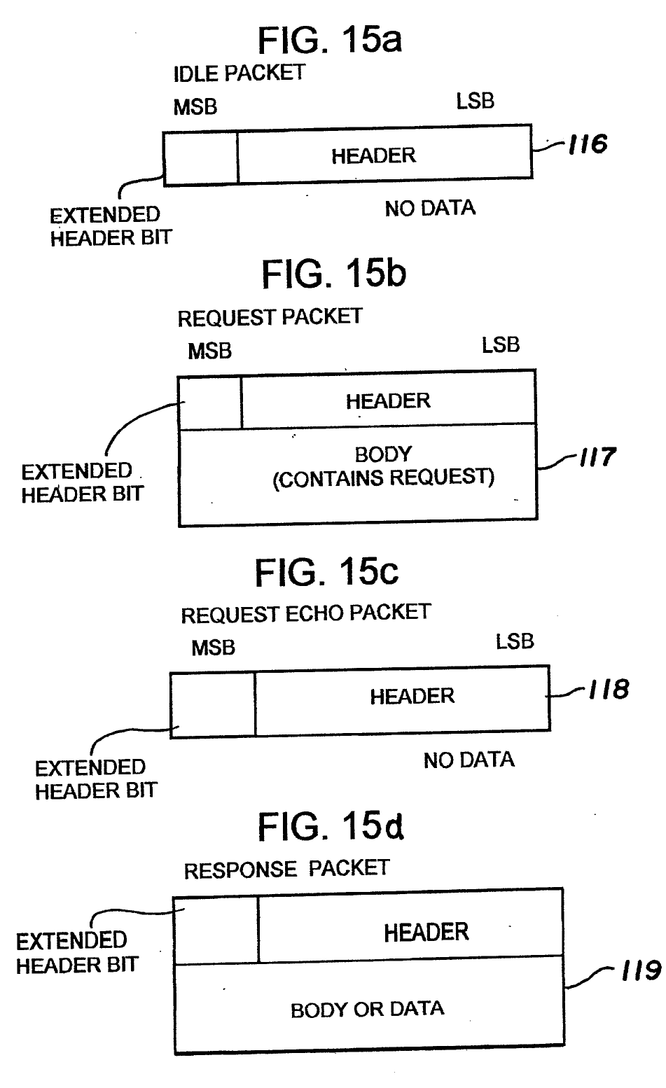

Any node 118 connected to the packet link 115 can generate these four classes of packets whose general structure is shown in FIGS. 15a, 15b, 15c, 15d.

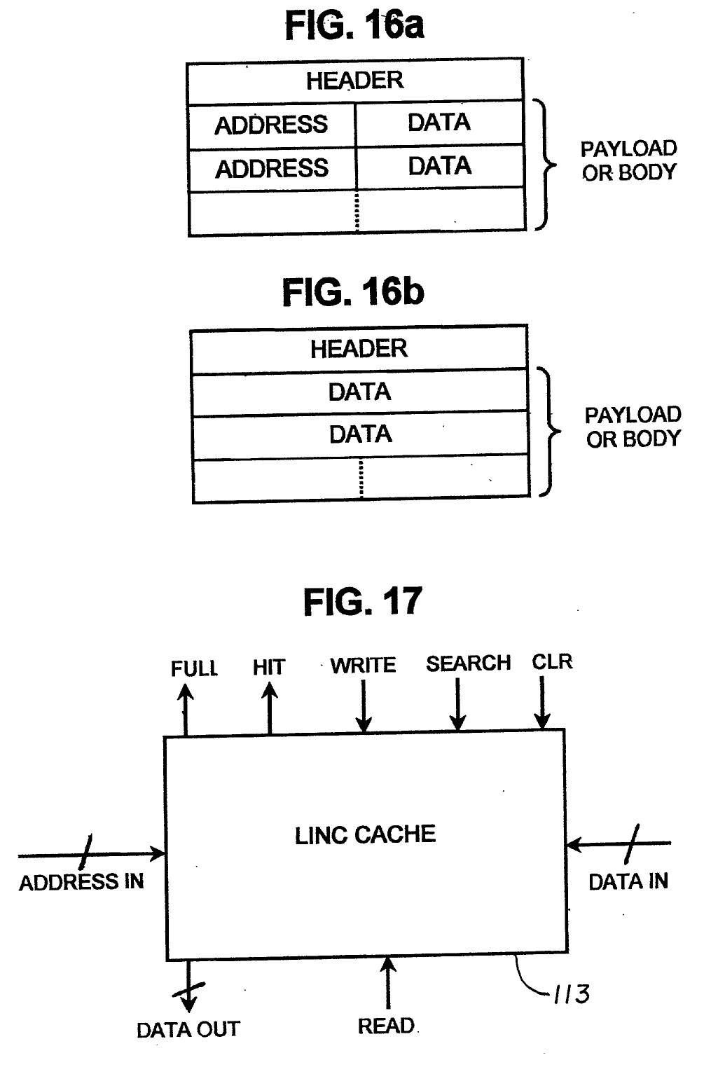

The general structure of the packet is as shown in FIG. 16. The data that comes over the link is in the form of packets. The data is then placed in the response queue 120 and written to the Linc cache 113 at the same time. The format of the data stored in the line cache is the same as that of the data in the packet. There are two possible formats for the data that is in the body of the packet. These two formats are shown in FIGS. 16a and 16b.

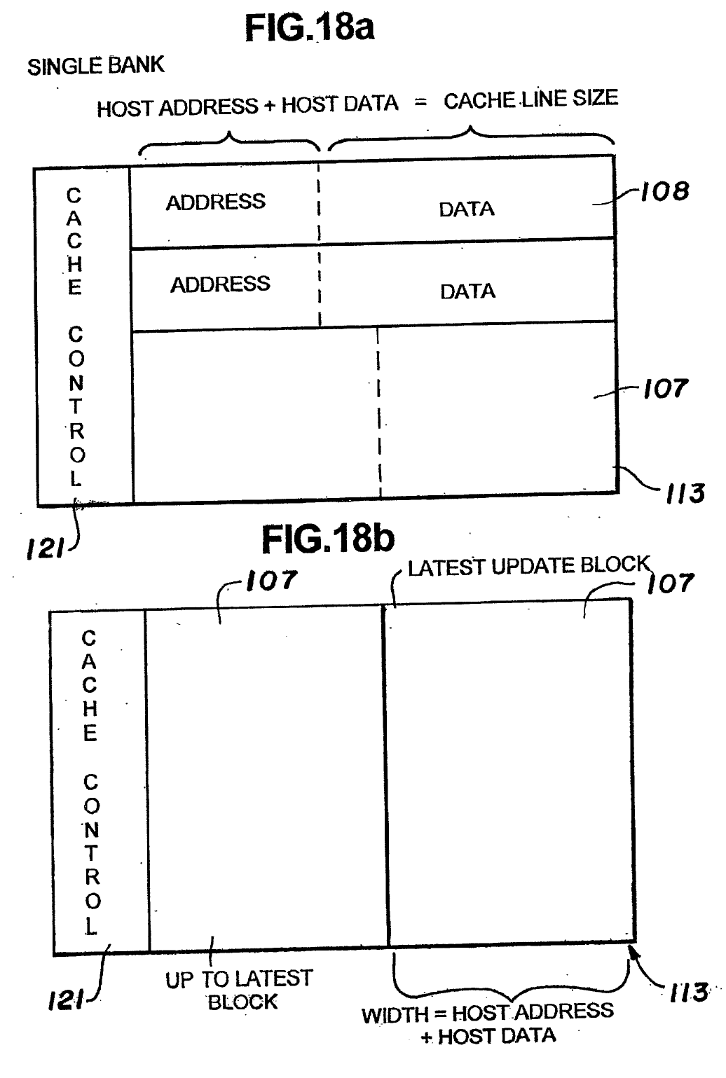

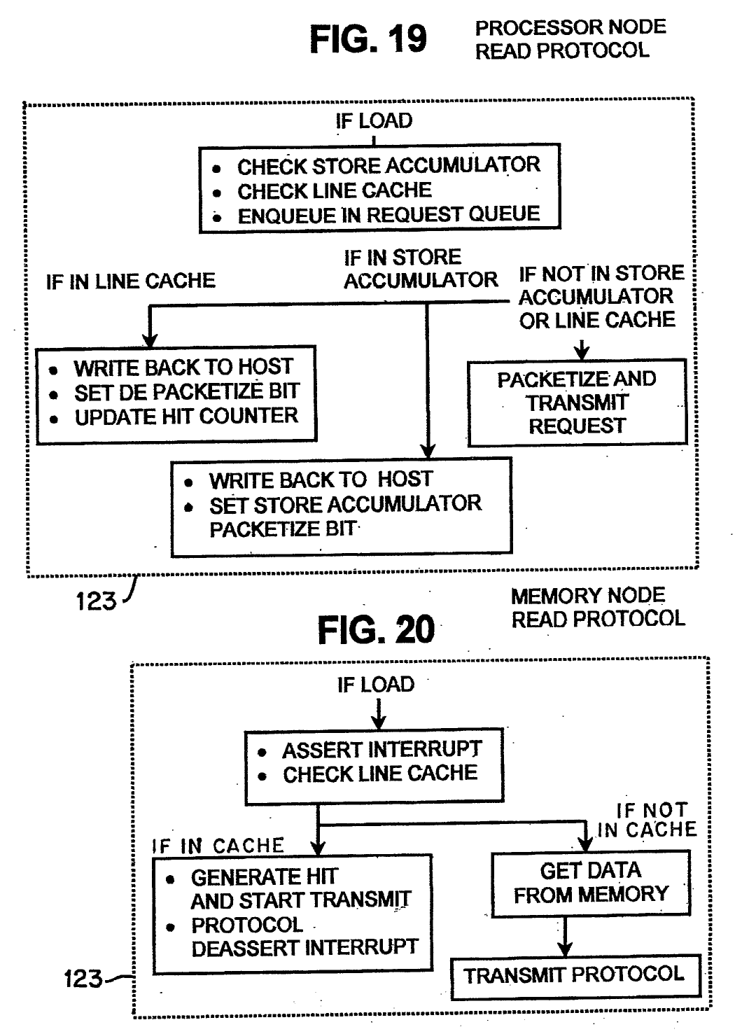

The general Interface of the line cache is as shown in FIG. 17. The line cache can be implemented as a single bank 107 or two banks as shown in FIGS. 18a and 18b. Each physical cache line 108 in the linc cache 113 is the size of the host address plus host data cache line.

There is a linc cache controller 121 that is associated with the cache. This controller 121 can be part of the linc controller as shown in FIG. 14. Or a stand alone controller if the cache is included by itself in another node 116, i.e., if it forms the processor L1 cache 102. In the case of the cache forming the processor L1 cache the lines would be split up into Tags (address) 103 and actual data as shown in FIG. 18a.

When a read access is made from the processor node 114 the linc cache 113 is searched for the appropriate address hit. If there is a hit, then the line cache outputs the data associated with that address, i.e., the data in the appropriate cache line 108. If there is a miss then the cycle is propagated to memory.

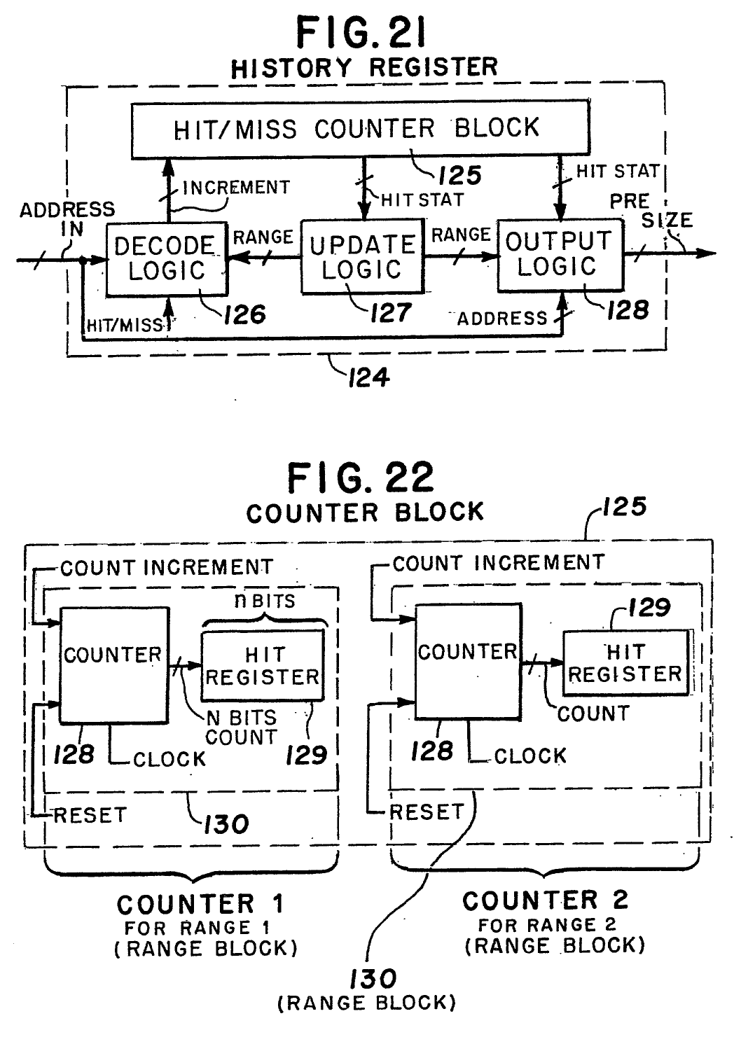

The cache that is present in the linc on the processor node and the memory node is searched when there is a read/load request from the processor. The read protocol 123 on the processor node is shown in FIG. 20. The read protocol 123 on the memory node is shown in FIG. 21. On the processor node linc cache, the result of the search (Hit/Miss) in the cache is passed to the history register 124.

A typical application running on a computer, or more specifically a processor is expected to make many data accesses to memory in reference with instructions being executed or to fetch instructions in reference to an application. These accesses are typically randomly distributed over time, over a certain range of addresses. In certain applications however, the accesses to memory exhibit what is called spatial and temporal locality. Spatial locality means that there is certain order in what locations in memory are consecutively accessed by the processor. Temporal locality is when certain locations in memory are repeatedly accessed in a given time slot.

The history register 124 is functionally a “memory” element to compile statistics on the data accesses by the node that contains the cache, for a given time. The intention of the history register is to study the memory accesses by the processor and to use this data to determine the size of data that can be pre-fetched in the next cycle if the memory access is to a certain address in memory. The history register is checked for the hit/miss information when a request to fetch data from memory is being determined by the packet interface 115. The history register 124 will also contain logic that determines the prefetch size from a certain address to be included in the request packet 117 being generated by the packet interface 115.

A functional block diagram of the history register 124 is shown in FIG. 22. The history register is composed of a counter block 125, decode logic block 126, update logic block 127, output logic block 127. The functionality of each of these blocks is explained in the description that follows.

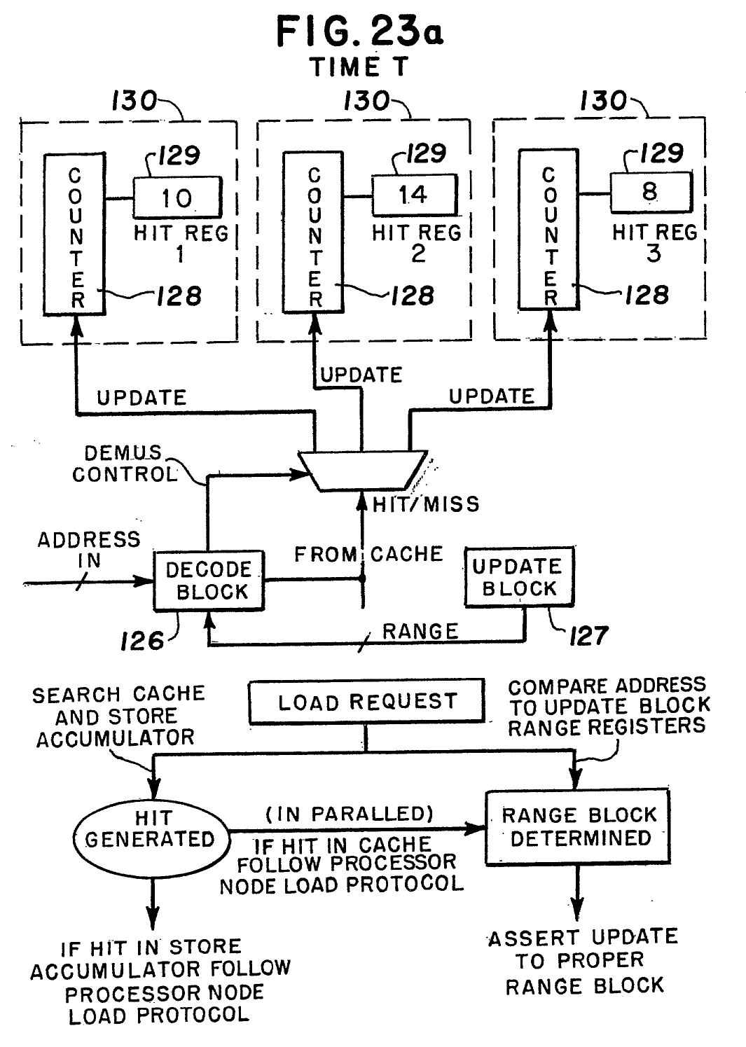

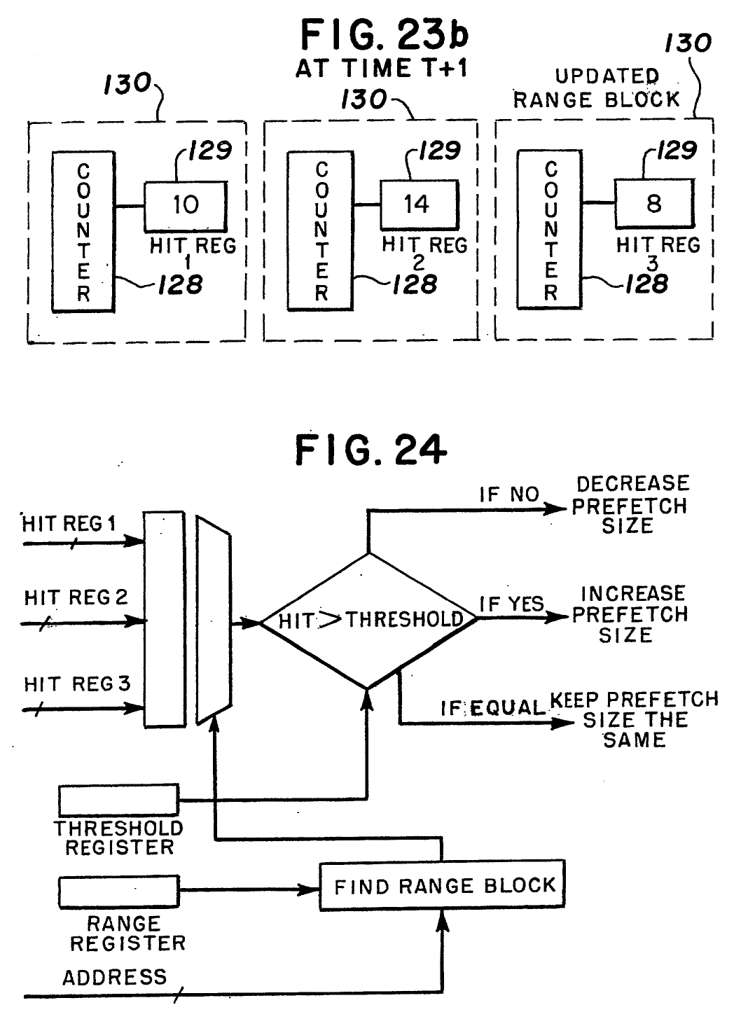

With respect to FIG. 23 the counter block 125 is composed of elements such as counters 128 and registers 129 that get updated from the hit/miss signal from the line cache. It is in the counter block that the profile of the data accesses is maintained. This block can be made programmable to maintain both HIT and MISS statistics or to maintain just HIT statistics. An embodiment of the counter block is shown in FIG. 23. The counter block contains multiple counters and registers associated with them. Each pair of the counter 129 and register 130 form a range block 131. The total address range represented by this counter block is: start address of range block 0 to the end address of range block n.

The update logic block 127 determines the granularity of the address ranges covered by each of the range block 131 elements in the counter block 125. The update logic block 127 can run in two modes, automatic or user programmed. The user can input data specifying the total address range of the counter block or based on the type of host the link is interfacing to, in auto mode it start with a default setting. This default setting is updated regularly to change the granularity of the address. The decode block takes the data from the individual registers in the counter block to determine the profile of the memory accesses.

Initially the counter block might represent the whole address space of the host or the processor node. Then each of the range blocks will store statistics on address ranges equal host address space/number of range blocks in the counter block. After a certain time, say 5 seconds, the update block checks the hit statistics in each of the range blocks and decides that there is an overwhelming number of hits in range block 1. The range block 1 address is taken as the new address range for the counter block. The address range represented by each of the counter blocks now equal address of range block 1/total number of range blocks in the counter block. This process is updated after a set time that can be stored in a register at start time. The set time can also be changed as time goes by, if the distribution of hits in the address ranges represented by the range blocks is too random or sparse. This increases the granularity of the addresses ranges and also accuracy of predicting the appropriate prefetches as time goes on for a particular application.

The idea here is to fit these memory accesses to a certain distribution. There are different kinds of distributions that are mentioned in reference (Kreizig Advanced Engineering Mathematics) or in other probability and statistics books. For a given profile of the memory accesses and the type of distribution they fit, the output logic block 128 takes the incoming address and compares it with the profile and generates the size and the prefetch.

The decode logic block 126 takes the incoming address from the load request and the HIT/MISS data and determines which range block in the counter block should be updated to reflect the hit/miss. This is done in conjunction with the update logic block 127 as the update logic block contains the information on how the address ranges are mapped on to the different range blocks in the counter block.

The use of this history register is understood with reference to FIG. 23. At some time T the status of each of the range blocks in counter block is as shown in FIG. 23a. A new load request comes in from the processor node or the host node. There is a hit in the line cache for the load request. The decode logic block then takes the address and compares it with the address distribution stored in the update block and determines the range block to which the increment signal is to be sent. This updates the appropriate range block to the new value as shown in FIG. 23b.

At some time T+T′ a new load request comes in, this time there is a miss in the line cache and all the other elements in the line. A new memory access cycle needs to be started. While the search request was being catered to, the output logic block takes the incoming address and determines the size of the prefetch.

The size of the prefetch to be encoded in the request packet can be determined in several ways. Two embodiments are shown for that in this particular case. One is a linear method. The other is a non-linear method, which takes advantage of probability theory.

The linear method, is as shown in FIG. 24. The output block compares the address of the load request with each of the range blocks to see which address range it falls in. Once appropriate range block is found then it takes the number of hits in the range block and compares it with the hit ratio equal number of hits in range block/maximum possible hits in range block, and determines whether the hit ratio justifies increasing the prefetch size or even decreasing the requested packet size. The justifying hit ratio can be a certain number, say 0-100% which can be determined by the system in auto mode or can be programmed externally. The range of addresses has a direct relationship to the prefetch size, i.e., if prefetch size is 32 bytes and each word is 8 bytes, the address range is request address plus 4.

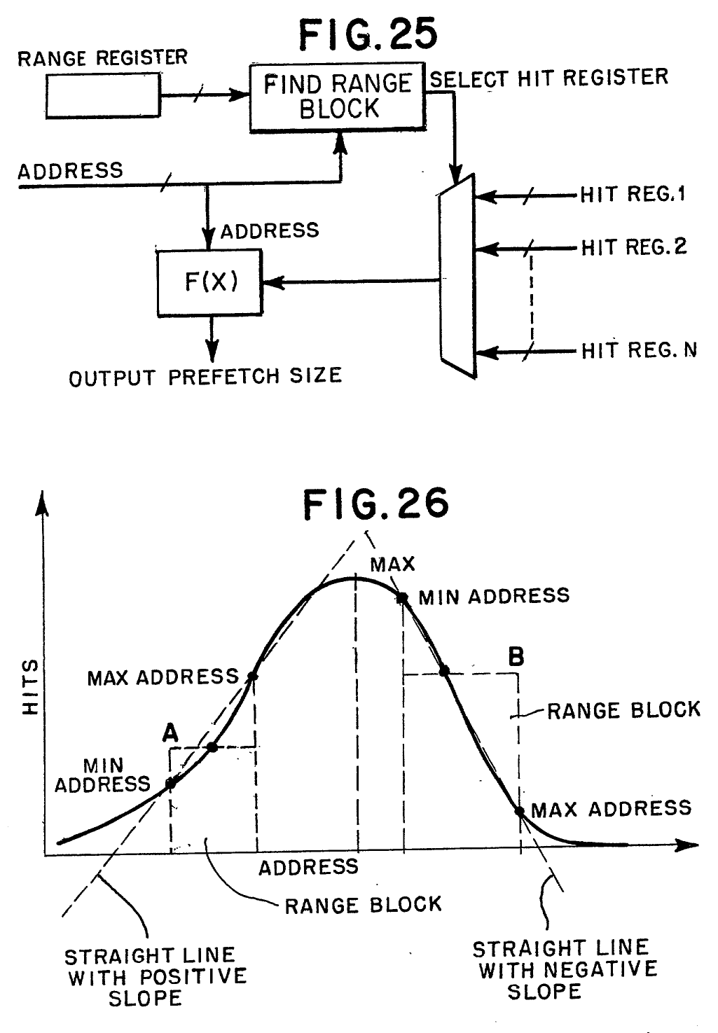

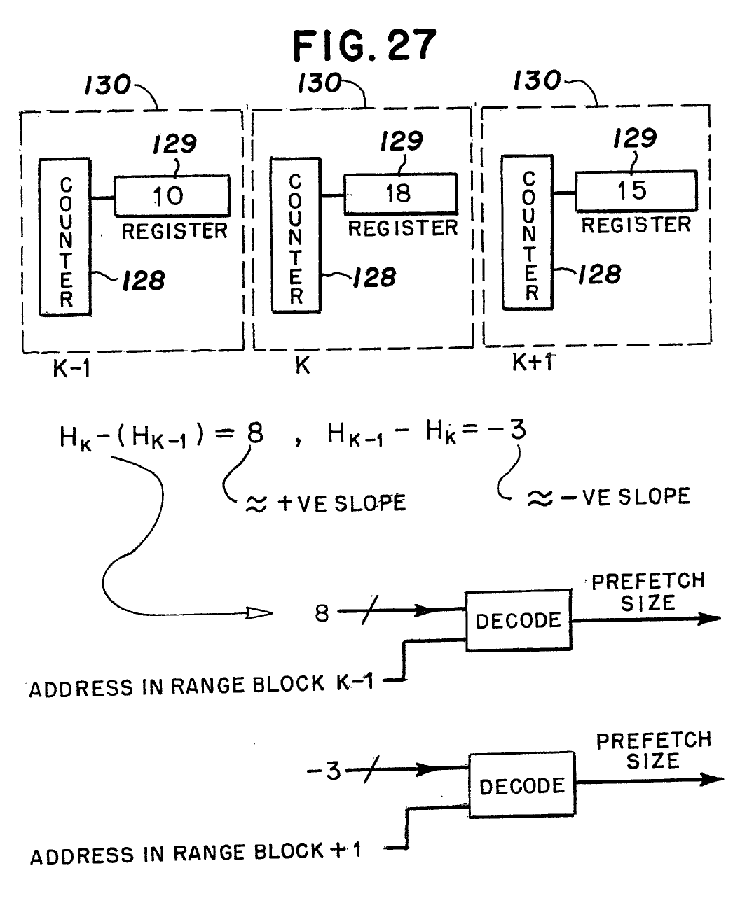

The non-linear method is shown in FIG. 25. The incoming address is compared to each of the range blocks to determine where it falls. The logic inside the output block is the representation of a function F that best figs the hit data stored in the counter block. Let's assume that the hits are distributed according to a distribution as shown in FIG. 26. With respect to FIG. 26, the new address falls at point A on the distribution function. The prefetch then has to include addresses that are to the right of point A (towards the maximum) to increase the probability of a hit on the next load request. With respect to FIG. 26 is the address falls at point B then the prefetch addresses will include addresses to the left of point B. The size of the prefetch is then proportional to the hits corresponding to the points A or B. The way that the prefetch is determined from FIG. 26, is that if we consider FIG. 26, the maximum address for hit B falls to the right of B and the minimum address bound for the range in which B falls lies to the left of B. If these points were joined by a straight line then the line would have a negative slope. Similarly if we look at address A then the maximum of the range would fall towards the right of A and the minimum would fall to the left of A. Again, if these points are joined by a straight line then the line would have a positive slope. Refer to FIG. 27. If the counters store the information as shown in FIG. 27, with the maximum count being stored in counter K, then we find ((Hk+1)−Hk)=d1 and (Hk−(Hk−1))=d2. D1 will always be negative, D2 will always be positive. These values are directly proportional to the slope of our straight line approximation in the intervals of the given address ranges corresponding to Hk, Hk−1, Hk+1. A lookup table is stored in the output block with entries in the first column which indicate the difference and the entries in the second column indicate the prefetch size. So, it is a matter of looking up the lookup table and deciding the size of the prefetch. The designer can determine the entries of the prefetch table by whether he wants to pre-calculate the values based on f(x) which represents the distribution of FIG. 27. Or if he wants to use the values from a straight line approximation. This proportionality can be chosen by the user again based on the design efficiency.

The method outlined in this invention is not limited to implementing a variable block or line size in the linc cache but can be implemented in any sort of cache in conjunction with an element such as a history register.

While a particular embodiment of the invention has been shown and described, it will be obvious to those skilled in the art that changes and modifications may be made therein without departing from the invention in its broader aspects, and, therefore, the aim in the appended claims is to cover all such changes and modifications as fall within the true spirit and scope of the invention.

I claim:

1. AN apparatus for implementing a variable block size cache, comprising:
register means for determining an address range;
counter means for determining the percentage of hits within selected blocks of said address range; and
means for selecting access length based on said percentage of hits within each block.

2. An apparatus for implementing a variable block size cache as defined in claim 1 further including means for determining an additional access length based on a percentage of misses within each block.
